(19) United States
(12) Patent Application Publication
(10) Pub. No.: US 2022/0406509 A1
(43) Pub. Date: Dec. 22, 2022

(54) TRANSFORMER ARRANGEMENT

(71) Applicant: SAAB AB, Linköping (SE)

(72) Inventors: Anders ROSENGREN, Järfälla (SE); Jonas FINNMAN, Solna (SE)

(21) Appl. No.: 17/807,286

(22) Filed: Jun. 16, 2022

(30) Foreign Application Priority Data
Jun. 18, 2021 (SE) 2100103-7

(51) Int. Cl. H01F 27/02; H01F 3/00; H01F 27/30

(52) U.S. Cl. CPC H01F 27/025; H01F 3/00; H01F 27/306; H01F 2003/005

(57) ABSTRACT

The present disclosure relates to a transformer arrangement (1) for mounting in an electrical power unit of a vehicle. The arrangement (1) comprising a transformer core (2) and a thermal shell (3) in contact with said transformer core (2). The transformer core (2) comprises a plurality of winding portions (4) extending from a common centre portion (c1) of said core (2), along a first axis (x1), a second axis (x2) and a third axis, (x3) each axis (x1, x2, x3) being orthogonal relative to each of the other axis (x1, x2, x3). Furthermore, each winding portion (4) comprises a conductive coil arrangement (5) wound around each winding portion (4).

### TECHNICAL FIELD

The present disclosure relates to a transformer arrangement comprising a transformer core and a thermal shell in contact with said transformer core. Further, the disclosure relates to a vehicle comprising a transformer arrangement.

### BACKGROUND ART

For all electronic equipment size and weight are of utmost importance. In many electrical applications magnetic components are large, cumbersome and accounts for a great portion of the weight. This is especially true for electrical power units where both large filters and isolating transformers are magnetic components made out of iron of some sort. In e.g. the primary power unit (PPU) in an airborne vehicle, the weight of the transformers is many kilograms compared to the total weight of the PPU. Conventionally, it is not rare that the transformers approximately make up half of the total weight of the PPU. Further, transformers, and specifically transformers in vehicles tend to induce losses (e.g. hysteresis losses or eddy losses), which specifically for a moving object is a great drawback.

Furthermore, transformers usually have poor thermal conductivity which is dependent on their thermal resistance. Accordingly, thermal resistance is proportional to the area of the transformer. In other words, to decrease the thermal resistance a larger area of the core is utilized in conventional transformer solutions—which in turn increases the weight of the transformer.

Thus, the transformers in the market today, and specifically transformers mounted in vehicles, are heavy structures which usually have a high thermal resistance and additional drawbacks such as losses.

Based on the above, there is room for transformers in the present art to explore the domain of providing an improved transformer arrangement compared to previous solutions. There is specifically a lack in the present art of how to improve a transformer arrangement to provide it with a reduced weight, decreased thermal resistance and with lower losses. Accordingly, there is room for improvements in the art to provide means for such transformer arrangements and vehicles containing such transformer arrangements.

Even though some currently known solutions work well in some situations it would be desirable to provide a transformer arrangement and a vehicle comprising a transformer arrangement that fulfils requirements related to reducing weight, decreasing thermal resistance and lowering losses.

### SUMMARY OF THE INVENTION

It is therefore an object of the present disclosure to provide a transformer arrangement and a vehicle to mitigate, alleviate or eliminate one or more of the above-identified deficiencies and disadvantages.

This object is achieved by means of a transformer arrangement as defined in the appended claims.

The present disclosure is at least partly based on the insight that by providing an improved transformer arrangement and a vehicle having reduced weight and decreased thermal resistance and lowered loss the transformer arrangement will at least have an improved performance, be cheaper and more convenient to implement, operate and produce.

In accordance with the disclosure there is provided a transformer arrangement according to claim 1 and a vehicle according to claim 13.

The present disclosure provides a transformer arrangement for mounting in an electrical power unit of a vehicle comprising a transformer core and a thermal shell (i.e. thermally conductive shell) in contact with said transformer core. The transformer core comprises a plurality of winding portions extending from a common centre portion of said core, along a first axis, a second axis and a third axis, each axis being orthogonal relative to each of the other axis; wherein each winding portion comprises a conductive coil arrangement wound around each winding portion.

A benefit of the transformer arrangement in accordance with the disclosure is that it provides for an arrangement that allows for the saturation of magnetic material in a plurality of dimensions and thus utilize a larger percent of the material in the transformer arrangement simultaneously. Consequently a significant weight reduction is achievable. However, a larger utilization of the material of the transformer may lead to higher effects which in turn increases the heat, however the transformer arrangement herein having a shell allows for excess heat to be lead away from said core.

Further, by having the transformer shell in contact with the core, the shell provides for a return path for the magnetic flux along the periphery of the magnetic core. This may result in the benefit of achieving an improved (increased) inductance in the transformer arrangement. This also results in a surface that can be easily thermally managed, greatly improving and reducing the thermal resistance. It may be Further also allowing for maintaining a high power in the transformer arrangement as cooling is a vital part in transformer arrangements—bad cooling attributes results in that the transformer cannot be operated to a high power. Accordingly, the shell provides at least a magnetic return path and a cooling surface. Thus, the form and properties of the shell allows for that excess heat may be led away from the transformer core in a convenient manner.

The thermal shell may be formed in a material being thermally conductive and magnetic. A benefit of this is that it allows for the material to lead magnetic flux as well as having the properties of being easily thermally managed.

The thermal shell and the transformer core may be formed in the same material. Thus, allowing for a more convenient manufacturing procedure.

The thermal shell of the transformer arrangement may be in contact with/connected to a cooling source arranged to cool said transformer core. In other words, the transformer arrangement may comprise a cooling source in contact with said thermal shell, i.e. an outer surface of said thermal shell. Thus, the thermal shell may be in-between said cooling source and said transformer core.

The transformer arrangement may further comprises a rectification circuit for rectifying a current/voltage. The rectification circuit may be a 12-pulse rectifying circuit. Allowing for the transformer to convert current/voltage.

The transformer core may be formed as an integral structure. Providing the benefit of an easy manufacturing process

The transformer core may be in an isotropic magnetic material, preferably ferrite and the thermal shell may be formed in ferrite. This allows for a transformer arrangement having good magnetic properties as well as being easily thermally managed.

The thermal shell may be in the form of a cube. The cube may have 6 flat surfaces, allowing the transformer arrangement to be thermally managed in an efficient manner. Thus, such a shape can easily be attached to e.g. a metal unit, cooling source or any other suitable thermally leading unit so to lead heat away from the transformer arrangement.

There is further disclosed a vehicle comprising an electrical power unit and the transformer arrangement according to the disclosure herein, wherein the transformer arrangement is mounted in said electrical power unit. The vehicle may be a ground-vehicle, a ship or an airborne vehicle.

### BRIEF DESCRIPTION OF THE DRAWINGS

In the following the disclosure will be described in a non-limiting way and in more detail with reference to exemplary embodiments illustrated in the enclosed drawings, in which:

FIG. 1 illustrates an objective view transformer arrangement in accordance with an embodiment of the present disclosure;

FIG. 2A illustrates an objective view of a transformer core in accordance with an embodiment of the present disclosure;

FIG. 2B illustrates a side view of a transformer core in accordance with an embodiment of the present disclosure;

FIG. 3 illustrates a cross-section of a side-view of a transformer core in accordance with an embodiment of the present disclosure; and

FIG. 4 illustrates a vehicle comprising a transformer arrangement in accordance with an embodiment of the present disclosure.

### DETAILED DESCRIPTION

In the following detailed description, some embodiments of the present disclosure will be described. However, it is to be understood that features of the different embodiments are exchangeable between the embodiments and may be combined in different ways, unless anything else is specifically indicated. Even though in the following description, numerous specific details are set forth to provide a more thorough understanding of the provided transformer arrangement and vehicle, it will be apparent to one skilled in the art that the transformer arrangement and vehicle may be realized without these details. In other instances, well known constructions or functions are not described in detail, so as not to obscure the present disclosure.

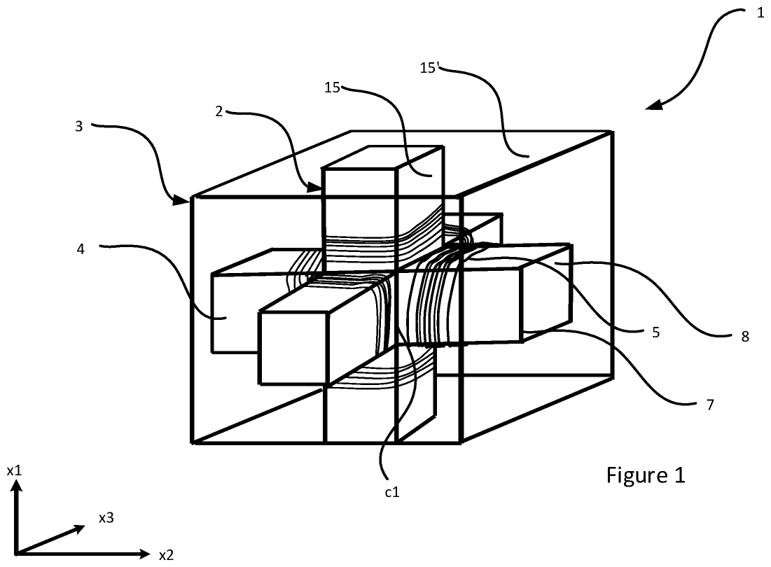

FIG. 1 illustrates an objective view of a transformer arrangement 1 in accordance with an embodiment of the present disclosure. The transformer arrangement 1 comprises a transformer core 2, and a thermal shell 3 in contact with said transformer core 2. The transformer core 2 comprises a plurality of winding portions 4 extending from a common centre portion c1 of said core 2, along a first axis x1, a second axis x2 and a third axis x3, each axis x1, x2, x3 being orthogonal relative to each of the other axis x1, x2, x3, wherein each winding portion 4 comprises a conductive coil arrangement 5 wound around each winding portion 4.

As further shown in FIG. 1, the first axis x1 is perpendicular to both the second axis x2 and the third axis x3, wherein the second axis x2 is perpendicular to the first axis x1 and the third axis x3, wherein the third axis x3 is perpendicular to the first and the second axis x1, x2.

Each winding portion 4 of said transformer core 2 comprises, at a distal end 7, a contact surface 8, wherein said thermal shell 3 is in contact with each of said contact surfaces 8 i.e. enclosing said core 2. In other words, Thus, allowing for a twofold gain, providing a return path of magnetic flux (reducing leakage flux) as well as providing a surface (i.e. the surfaces of the thermal shell 3) that can be easily thermally managed, greatly improving and reducing the thermal resistance when compared to conventional transformer arrangements. The thermal shell may be formed in a material being thermally conductive and magnetic. In some embodiments, the thermal shell and the transformer core are formed in the same material. The material may be ferrite. Moreover, the thermal shell 3 may be in the form of a cube as seen in FIG. 1, allowing it to be mobile and easily integrated in e.g. a power unit in a vehicle, further allowing it to be thermally managed easier. As further shown in FIG. 1, the thermal shell 3 may be in the form of a cube enclosing/surrounding said transformer core. In other words, an outer surface area 15 of said thermal shell 3 may be greater/larger than an outer surface area 15′ of said transformer core 2.

The transformer core 2 may comprise magnetic material and as shown in FIG. 1, the transformer core 2 is dimensioned orthogonally in three axis x1, x2, x3, allowing to utilize a larger percent of magnetic material simultaneously. For isotropic magnetic materials like ferrite, magnetic flux is a vector quantity (an example of practical use is 3D magnetometer). The saturation properties may occur in the same manner. The present disclosure may allow flow of three times as much magnetic flux in the same material without saturation. Further, the present disclosure provides for weight reduction. The transformer core 2 may be formed as an integral structure. The transformer core 2 may be in an isotropic magnetic material, preferably ferrite. The thermal shell 3 shown in FIG. 1 may have any suitable thickness.

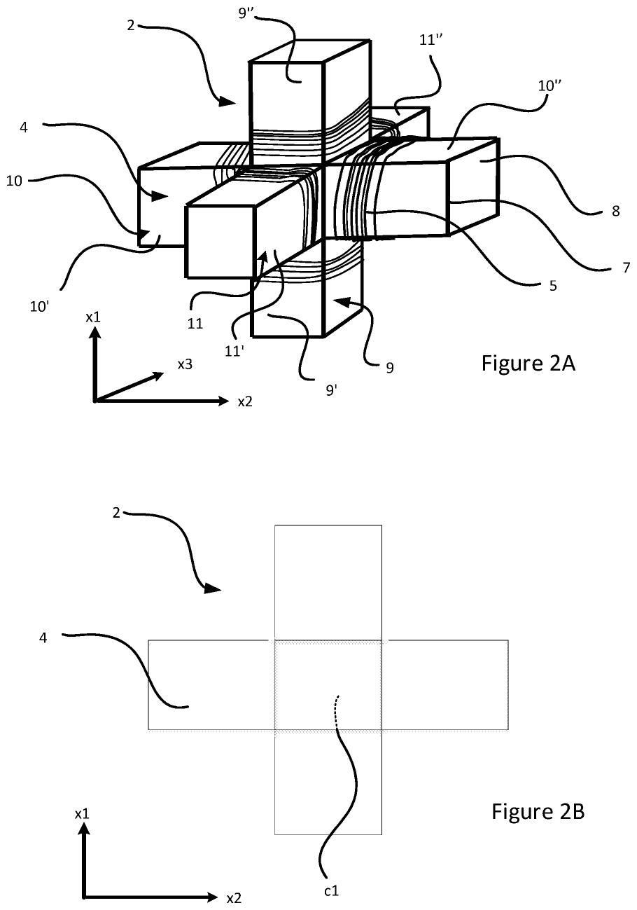

As shown in FIG. 2A, the transformer core comprises a first 9, a second 10 and a third pair 11 of winding portions 4, wherein each pair 9, 10, 11 of winding portions 4 extend opposite to each other along a corresponding axis x1, x2, x3. In other words, each pair of winding portions 4 extend along the same axis x1, x2, x3 in opposing directions. In other words, each pair of winding portions 4 extend away from the other along a common axis x1, x2, x3.

FIGS. 1 and 2A illustrate that the core 2 comprise a conductive coil arrangement 5, the conductive coil arrangement 5 may be a primary conductive coil arrangement connected to an input drawing power from a source and a secondary conductive coil arrangement connected to an output supplying energy to a load, wherein each pair of winding portions comprises a primary coil arrangement and a secondary coil arrangement dividedly wound around the pair of winding portions. Thus, the transformer arrangement 1 comprises three pairs 9, 10, 11 of winding portions 4, wherein each pair 9, 10, 11 comprises a primary conductive coil arrangement and a secondary conductive coil arrangement. Accordingly, there may be formed three transformer devices (formed by the coil arrangements around each pair), one extending along each axis x1, x2, x3. As shown in FIG. 2A, each pair 9, 10, 11 comprises a first and a second winding portion 9′, 9″, 10′, 10″, 11′, 11″.

Thus, a primary coil arrangement of one axis (i.e. for one pair 9, 10, 11) may for instance be wound 5 turns (5 being an exemplary number) around a first winding portion 10′ of a first pair 10, consequently, the same primary coil arrangement is divided to be further wound 5 turns around a second winding portion 10″ in the first pair 10. Moreover, each secondary coil arrangement may in the same manner be dividedly wound 5 turns around each winding portion 10′, 10″ in the pair 10. This may apply to each of the pairs 9, 10, 11. Accordingly, each portion 9′, 10′, 11′ of each pair comprises both a primary coil arrangement and a secondary coil arrangement which is shared with the other portion of the pair 9″, 10″, 11″ (i.e. forming three transformers, each for each pair along each axis).

The primary/secondary coil arrangement may each be dividedly wound so that there is a distance of one radius between the divided coil arrangements located on each pair 10.

The transformer arrangement 1 may further comprise a rectification circuit for rectifying a current/voltage. The rectification circuit may be a 12-pulse rectifying circuit (not shown).

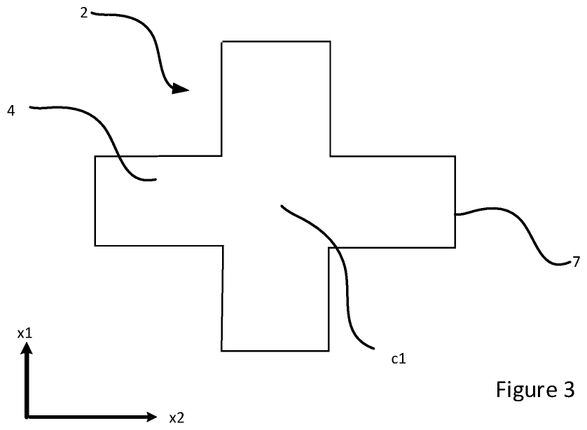

FIG. 2B illustrates the transformer arrangement 1 from a side view, as seen in FIG. 2B, each of the winding portions 4 are perpendicular to each of the other winding portions 4. Further, it is shown in FIG. 2B that the centre portion c1 is in the center of the transformer arrangement 1 and each winding portion 4 extend away from the centre portion c1. This is also seen in FIG. 3 in more detail, showing that the centre portion c1 is center of the core 2. FIG. 3 illustrates the transformer arrangement from a side, cross-sectional view.

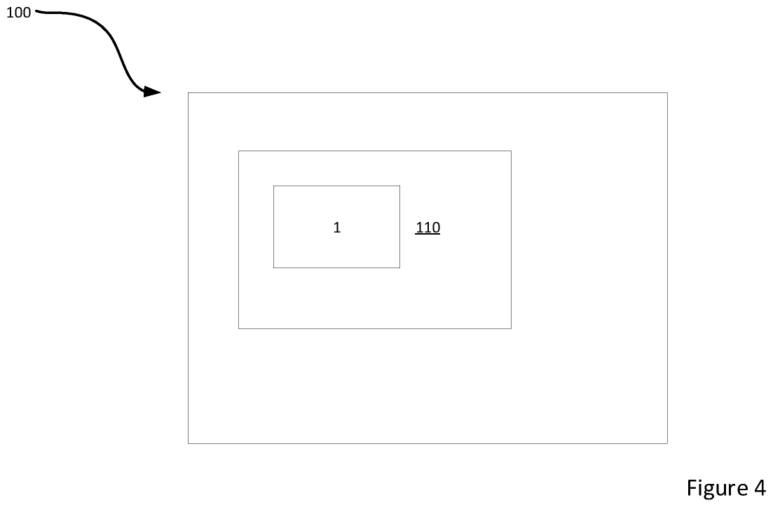

FIG. 4 schematically illustrates a vehicle 100 comprising an electrical power unit 110 and the transformer arrangement 1 according to the present disclosure, wherein the transformer arrangement 1 is mounted in said electrical power unit 110.

The vehicle may be a ground-based vehicle, an air-borne vehicle, a ship or a UAV.

1. A transformer arrangement (1) for mounting in an electrical power unit of a vehicle comprising:
a transformer core (2); and
a thermal shell (3) in contact with said transformer core (2);
wherein said transformer core (2) comprises a plurality of winding portions (4) extending from a common centre portion (c1) of said core (2), along a first axis (x1), a second axis (x2) and a third axis, (x3) each axis (x1, x2, x3) being orthogonal relative to each of the other axis (x1, x2, x3); wherein each winding portion (4) comprises a conductive coil arrangement (5) wound around each winding portion (4).

2. The transformer arrangement (1) according to claim 1, wherein each winding portion of said transformer core (2) comprises, at a distal end (7), a contact surface (8), and wherein said thermal shell (3) is in contact with each of said contact surfaces (8).

3. The transformer arrangement (1) according to claim 1, wherein the transformer core (2) comprises a first (9), a second (10) and a third pair (11) of winding portions, wherein each pair (9, 10, 11) of winding portions extend along a common axis (x1, x2, x3) away from the centre portion (c1).

4. The transformer arrangement (1) according to claim 1, wherein the conductive coil arrangement (5) is a primary conductive coil arrangement connected to an input drawing power from a source and a secondary conductive coil arrangement connected to an output supplying energy to a load, wherein each pair of winding portions (9, 10, 11) comprises a primary coil arrangement and a secondary coil arrangement dividedly wound around the pair of winding portions (9, 10, 11) respectively.

5. The transformer arrangement (1) according to claim 1, wherein the thermal shell (3) is formed in a material being thermally conductive and magnetic.

6. The transformer arrangement (1) according to claim 1, wherein the thermal shell (3) and the transformer core (2) are formed in the same material.

7. The transformer arrangement (1) according to claim 1, wherein said transformer arrangement (1) further comprises a rectification circuit for rectifying a current/voltage.

8. The transformer arrangement (1) according to claim 1, wherein the rectification circuit is a 12-pulse rectifying circuit.

9. The transformer arrangement (1) according to claim 1, wherein the transformer core (2) is formed as an integral structure.

10. The transformer arrangement (1) according to claim 1, wherein said transformer core (2) is in an isotropic magnetic material, preferably ferrite.

11. The transformer arrangement (1) according to claim 1, wherein said thermal shell (3) is in the form of a cube.

12. The transformer arrangement (1) according to claim 1, wherein the thermal shell (3) is formed in ferrite.

13. A vehicle (100) comprising;
a electrical power unit (110); and
the transformer arrangement (1) according to claim 1, wherein the transformer arrangement (1) is mounted in said electrical power unit.
